(19) United States
(12) Patent Application Publication
(10) Pub. No.: US 2025/0167239 A1
(43) Pub. Date: May 22, 2025

(54) Electrode Composition and Electrode Comprising Same

(71) Applicant: Bayerische Motoren Werke Aktiengesellschaft, Muenchen (DE)

(72) Inventors: Sung-Jin KIM, Muenchen (DE); Thomas WOEHRLE, Muenchen (DE)

(21) Appl. No.: 18/839,949

(22) PCT Filed: Mar. 15, 2023
(86) PCT No.: PCT/EP2023/056575

§ 371 Date: Aug. 20, 2024

(30) Foreign Application Priority Data
Apr. 5, 2022 (DE) 10 2022 108 147.8

(51) Int. Cl. H01M 4/62; H01M 4/02

(52) U.S. Cl. CPC H01M 4/625; H01M 2004/021; H01M 4/622

(57) ABSTRACT

An electrode composition for a lithium-ion battery is provided, the electrode composition comprising: (A) at least one electrode active material and (B) at least one mixture of conductive carbon blacks comprising at least a first conductive carbon black and a second conductive carbon black, the first conductive carbon black differing from the second conductive carbon black. An electrode comprising the electrode composition is further provided. A lithium-ion battery comprising the electrode is further provided. A process for the production of an electrode is further provided.

### BACKGROUND AND SUMMARY

The present disclosure relates to an electrode composition, to an electrode with the electrode composition, and to the use of the electrode in particular in a lithium-ion battery.

The term “lithium-ion battery” is used synonymously hereinafter for all designations commonplace in the art for galvanic elements and cells that contain lithium, such as, for example, lithium battery, lithium cell, lithium-ion cell, lithium polymer cell, and lithium-ion accumulator. In particular, rechargeable batteries (secondary batteries) are included. The terms “battery” and “electrochemical cell” are also used synonymously with the term “lithium-ion battery”.

A lithium-ion battery has at least two different electrodes: a positive electrode (cathode) and a negative electrode (anode). Movements of electrons and lithium ions in the cell therefore form an elementary function of lithium-ion batteries. The composition of the electrode, in particular, represents an important aspect with regard to the cell chemistry of the lithium-ion battery, since defined electrochemical properties (such as high-current robustness or cycling stability) of the lithium-ion battery can be tailored via suitable selection of the components present in the electrode composition.

Generally speaking, electrodes comprise at least one active material with the ability to take up and release lithium ions reversibly. To support the uptake and the release of lithium ions into the active material, and to further improve the properties of the electrode, it is common to admix the electrode with additions such as electrode binders and electrical conductivity additives. An electrode of this kind is also known in the art as a composite electrode.

For the production of a composite electrode, the individual components of the electrode composition must be intimately combined with one another so as to achieve not only effective contacting between the components but also a certain mechanical stability on the part of the electrode itself. In this context, the selection of the components in the electrode composition has consequences not only for the properties of the lithium-ion battery fabricated from it but also on the electrode production process. For example, some components lead to an improvement in the electrochemical and mechanical properties of the electrode, and yet have only poor processing qualities in the electrode production process, and vice versa.

It is therefore an object of the present disclosure to provide an electrode composition which enables simple and inexpensive production of a lithium-ion battery in terms of process costs and costs for materials, and which fulfills the electrochemical performance requirements which are set for use in a lithium-ion battery.

The object is achieved in accordance with the present disclosure by an electrode composition for a lithium-ion battery, according to claim 1.

Advantageous embodiments of the electrode composition of the present disclosure are specified in the dependent claims, which can be combined with one another as desired.

In accordance with the present disclosure, the object is achieved by an electrode composition, more particularly for a lithium-ion battery, wherein the electrode composition comprises the following components:
(A) at least one active electrode material; and
(B) at least one mixture of conductive carbon blacks which comprises at least a first conductive carbon black and a second conductive carbon black, the first conductive carbon black differing from the second conductive carbon black.

### DETAILED DESCRIPTION

The present disclosure is based on the fundamental concept of providing an electrode composition which comprises a mixture of at least two different conductive carbon blacks. The use of at least two conductive carbon blacks that are different from one another allows not only inexpensive provision of the electrode composition but also simple production of an electrode fabricated from the electrode composition. Moreover, the use, in accordance with the present disclosure, of two different conductive carbon blacks affords greater electrochemical and process-related variability for an electrode produced therefrom. Accordingly, the cell properties and production costs of a lithium-ion battery fabricated from the electrode composition of the present disclosure can be influenced in a targeted way.

There is in principle no limit, in relation to the electrode, on the electrode composition of the present disclosure for a lithium-ion battery. The electrode composition may be used both for a cathode and for an anode.

Accordingly, there is no limit either on the active electrode material provided in the electrode composition. It is therefore possible to use any active electrode material known in the art that is capable of forming an electrode, more particularly a cathode or an anode, of a lithium-ion battery.

It is therefore the case, depending on the corresponding use of the electrode composition, that the active electrode material may comprise either an active cathode material or an active anode material.

Suitable active cathode materials for the cathode may be any of the active cathode materials known in the art that are capable of taking up and releasing lithium ions reversibly.

Preferred active cathode materials for the electrode composition comprise lithium cobalt oxide (LCO), lithium nickel oxide (LNO), lithium nickel cobalt aluminum oxide (NCA), lithium nickel manganese cobalt oxide (NMC), lithium-and manganese-rich lithium nickel manganese cobalt oxide or lithium nickel manganese oxide (LMR), lithium manganese oxide (LMO), lithium iron phosphate (LFP), lithium manganese iron phosphate (LMFP), lithium nickel manganese oxide high-voltage spinel (LNMO), and derivatives and combinations thereof.

Lithium-nickel-manganese-cobalt oxide compounds are also known by the abbreviation NMC, and occasionally also alternatively by the technical abbreviation NCM. NMC-based active cathode materials are used especially in lithium-ion batteries for electric vehicles. NMC as active cathode material has an advantageous combination of desirable properties, such as, for example, high specific capacity, reduced cobalt fraction, high high-current capability, and high intrinsic safety, which is manifested, for example, in sufficient stability in the event of an overload.

NMCs may be described by the general formula unit Li_{α}NiₓMn_{y}Co_{z}O₂ with x+y+z=1, where a denotes the indicator of the stoichiometric fraction of lithium and is typically between 0.8 and 1.15. Defined stoichiometries are specified as three-figure numbers in the literature: for example, NMC 811, NMC 622, NMC 532 and NMC 111. The three-figure number in each case specifies the relative content of nickel: manganese: cobalt. In other words, for example, NMC 811 is a cathode material having the general formula unit LiNi_{0.8}Mn_{0.1}Co_{0.1}O₂, in other words, with α=1. In addition, it is also possible to use what are called lithium-and manganese-rich NMCs with the general formula unit Li1+ϵ(NixMnyCoz)1−ϵO2, where ϵ is in particular between 0.1 and 0.6, preferably between 0.2 and 0.4. These lithium-rich layered oxides are also known as overlithiated (layered) oxides (OLOs).

There is likewise no limit on the active anode material, and any active anode material in the art may be used that is capable of taking up and releasing lithium ions reversibly.

The active anode material is preferably selected from the group consisting of synthetic graphite, natural graphite, graphene, meso-carbon, doped carbon, hard carbon, soft carbon, fullerene, silicon-carbon composite, silicon, nano-silicon, surface-coated silicon, silicon suboxide (SiOx), silicon alloys, metallic lithium, aluminum alloy, indium, indium alloys, tin alloys, cobalt alloys, and mixtures thereof.

In accordance with the present disclosure, as well as the at least one active electrode material, the electrode composition comprises at least one mixture of conductive carbon blacks which comprises at least a first conductive carbon black and a second conductive carbon black, the first conductive carbon black differing from the second conductive carbon black.

A conductive carbon black is understood hereinafter to be a para-crystalline, carbon-based, pulverulent material whose structure comprises predominantly ungraphitized regions, in other words., amorphous regions, and partially graphitized regions, in other words, crystalline regions. Generally speaking, conductive carbon black structurally does not have any regions with sp3 hybridization as is the case, for example, in carbon with a diamond structure. Conductive carbon black is also widely known as industrial carbon black or simply as carbon black.

As well as containing carbon, a conductive carbon black may, as a result of the production of the conductive carbon black, also have a small fraction of hydrogen, oxygen and/or sulfur, in the form of functional polar groups such as acid or acid anhydrides or carboxylates.

A feature of conductive carbon blacks is their advantageous electrical conductivity. Through the use of a conductive carbon black, therefore, the electrical conductivity of an electrode can be increased. In particular, this affords the technical advantage that an electrode featuring increased conductivity, generally speaking, improves the electrochemical properties, such as high-current robustness, of a lithium-ion battery fabricated from it.

Especially suitable for usage in batteries are conductive carbon blacks having an electrical conductivity of at least 0.1 S cm−1, preferably at least 1 S cm−1, more preferably at least 4 S cm−1.

There is in principle no limit on the present disclosure in terms of the number of conductive carbon blacks, provided the mixture of conductive carbon blacks comprises at least two different conductive carbon blacks. It is also possible, accordingly, for there to be a plurality of conductive carbon blacks in the mixture. For example, a mixture of three or four different conductive carbon blacks may be used in the electrode composition.

According to one aspect, the first conductive carbon black differs from the second conductive carbon black in at least one of the following properties:
mean particle diameter;
particle size distribution;
secondary structure;
specific BET surface area;
electrical conductivity;
oil absorption coefficient;
bulk density;
tap density;
mode of production;
impurities; and/or
surface nature.

Conductive carbon blacks are present fundamentally in the form of particles. A distinction may be made between primary particles and secondary particles. Primary particles represent the isolated, in other words, unagglomerated, particles of the conductive carbon blacks used. Primary particles, however, may agglomerate with one another or associate with one another. Such agglomerates of primary particles are referred to as secondary particles or secondary structure.

According to a further aspect, the first conductive carbon black and the second conductive carbon black each have a particle size distribution of primary particles having a mean particle diameter (d50) in a range from 1 to 1000 nm, preferably 10 to 100 nm, the mean particle diameter of the first conductive carbon black differing from the mean particle diameter (d50) of the second conductive carbon black by at least 10%, preferably by at least 15%. The particle size distribution and the mean particle diameter (d50) may be ascertained by electron micrographs (TEM).

Through the use of at least two different conductive carbon blacks, differing in particular in terms of the mean particle size, it is possible to achieve reduced mixing times in electrode production for the same cell performance properties.

Electrode production is briefly addressed below.

First of all, in the production of an electrode for a lithium-ion battery, generally speaking, the active electrode material is mixed with the conductive carbon black and electrode binder in a suspension comprising a carrier solvent. In a mixing process, the conductive carbon black is homogenized and dispersed together with the active electrode material in the carrier solvent. A homogenized mixture composed of the active electrode material and a conductivity additive and binder in a carrier solvent is also referred to as an electrode coating slurry. The homogenized mixture can then be used to coat a metallic current collector, for example, a rolled aluminum foil, to form a completed electrode.

These mixing processes are oftentimes long-lasting and require the input of high quantities of mechanical energy to achieve the desired homogeneity of the electrode coating slurry. An inhomogeneous electrode coating slurry diminishes the electrochemical properties—for example, the lifetime—of an electrode produced therefrom and hence also those of the lithium-ion battery, due in particular to inadequate mixing of the components. The inventors have recognized, however, that a shorter mixing time is achievable by the mixing of two conductive carbon blacks having different properties, in particular a different particle diameter in each case. Surprisingly, however, the shorter mixing time does not result in reduced electrochemical performance or lifetime for the lithium-ion battery produced from the electrode composition.

According to a further aspect, with an electrode composition which comprises a mixture of two different conductive carbon blacks, differing at least in terms of the mean particle diameter of the primary particles, further advantageous properties of the electrode composition can be established.

In particular, the use of conductive carbon blacks having a relatively large mean particle diameter may lead to a lower oil absorption coefficient, since the interaction of the conductive carbon blacks with the carrier solvent reduces with increasing particle size. It is therefore possible to use less carrier solvent to form the electrode coating slurry and to increase the solids fraction in the slurry. On the other hand, the use of relatively small particles may lead to a higher oil absorption coefficient, resulting in higher take-up/wetting with the carrier solvent.

Through the use of conductive carbon blacks with larger particle diameters, additionally, a lower viscosity of the electrode coating slurry is achievable, whereas smaller particle diameters can lead to a higher viscosity of the electrode coating slurry.

The dispersibility of the conductive carbon blacks can also be influenced via the mean particle size. While the use of conductive carbon blacks with larger particle diameter leads to simplified dispersibility in the mixing process, smaller particle diameters may hinder the dispersibility of the electrode composition in the mixing process.

Moreover, the electrical conductivity of the electrode resulting from the electrode composition can be influenced by way of the particle size. Conductive carbon blacks having a larger particle diameter lead, generally speaking, to a lower electrical conductivity of the electrode, whereas conductive carbon blacks having a smaller particle diameter lead to a higher electrical conductivity of the resulting electrode.

The properties stated above can be tailored advantageously in the electrode composition through the use of a mixture of at least two conductive carbon blacks each having different particle size distributions with a differing mean particle diameter (d50) of the primary particles.

According to a further aspect, the mixture of conductive carbon blacks has a bimodal particle size distribution.

The mean particle diameter of the conductive carbon blacks and also the particle size distribution of the primary particles may be measured, for example, by evaluation of electron micrographs; with electron microscopy, for example, more particularly transmission electron microscopy.

According to a further aspect, the first conductive carbon black and the second conductive carbon black each have a BET surface area in a range from 1 to 1000 m² g−1, preferably 50 to 750 m² g−1, more preferably 100 to 400 m² g−1, the BET surface area of the first conductive carbon black differing from the BET surface area of the second conductive carbon black by at least 10%, preferably by at least 15%, more preferably at least 20%.

The BET surface area is determined according to ASTM D6556-04.

The selection of conductive carbon blacks differing in BET surface area gives rise to possibilities including that of interaction with the carrier solvent during the production of the electrodes. The use of conductive carbon blacks with larger BET surface areas allows for greater interaction with the carrier solvent, while smaller BET surface areas lead to less interaction. Consequently, through the use of a mixture of conductive carbon blacks, it is possible to tailor the interaction with the carrier solvent, so making it possible, among other things, to achieve shorter mixing times during electrode production.

According to a further aspect, the first conductive carbon black and the second conductive carbon black each have an oil absorption coefficient in a range from 1 to 800 mL (100 g)−1, preferably 40 to 400 mL (100 g)−1, the oil absorption coefficient of the first conductive carbon black differing from the oil absorption coefficient of the second conductive carbon black by at least 10%, preferably by at least 15%.

The oil absorption coefficient is determined according to ASTM D2414-06 a.

The oil absorption coefficient indicates the amount of oil or carrier solvent that can be taken up per 100 g of conductive carbon black. The oil absorption coefficient is therefore an important parameter in determining the interaction between the carrier solvent in the mixing process and the conductive carbon black. A relatively low oil absorption coefficient, for example, means that a smaller amount of carrier solvent can be used in the mixing process, thereby reducing the energy input associated with the drying. This in turn lowers the energy costs of the drying operation.

There is in principle no limit on the present disclosure in relation to the conductive carbon black. Fundamentally, any conductive carbon black known in the prior art for use in lithium-ion batteries may be used.

In one preferred embodiment, the mixture of conductive carbon blacks comprises at least two different conductive carbon blacks, wherein one conductive carbon black is obtainable from an incomplete combustion process and the other conductive carbon black from a thermal decomposition.

In other words, advantageously, two different conductive carbon blacks are used which differ in their mode of production.

Conductive carbon black from an incomplete combustion is also known as furnace black.

Conductive carbon black from a thermal decomposition is also referred to as acetylene black.

However, different specific types of carbon black may also be used, as for example channel black, lamp black or gas black.

Conductive carbon blacks suitable for applications in electrode compositions are available, for example, from the companies Denka, Japan; Cabot, USA; Akzo Nobel; and Imerys.

The first and second conductive carbon blacks may also have different secondary structures. The secondary structure is influenced by the mode of production of the respective conductive carbon black. It is, however, also conceivable for the secondary structure to be altered by factors including the input of high shearing forces when mixing the electrode coating slurries, at which point the electrical conductivity of the resulting electrode may go down. For example, the different secondary structures also result in different oil absorption coefficients. The secondary structures may be determined by electron micrographs (TEM).

According to a further aspect, the first conductive carbon black and the second conductive carbon black each have a bulk density in a range from 10 to 100 g/liter, the bulk density of the first conductive carbon black differing from the bulk density of the second conductive carbon black by at least 10%, preferably by at least 15%. The bulk densities are determined according to the standards DIN ISO 697 and EN ISO 60.

According to a further aspect, the first conductive carbon black and the second conductive carbon black each have a tap density in a range from 20 to 250 g/L, the tap density of the first conductive carbon black differing from the tap density of the second conductive carbon black by at least 10%, preferably by at least 15%. The tap densities are determined according to the standard DIN EN ISO 787-11.

The conductive carbon blacks may also comprise impurities. Conductive carbon blacks advantageously used are those containing a low fraction of impurities, in particular a low ash fraction, to prevent later gassing in the cell.

The conductive carbon blacks may also differ in their surface nature.

For example, the conductive carbon blacks may carry various polar groups such as H, O, S, OH, and COOH groups. In a further configuration, the first conductive carbon black is present in a fraction of 1% to 99% by weight in the mixture of the conductive carbon blacks, preferably 25% to 75% by weight, more preferably 45% to 55% by weight, based on the total weight of the mixture of the conductive carbon blacks.

Accordingly, the first conductive carbon black may be combined virtually ad infinitum with the second conductive carbon black.

Besides the abovementioned conductive carbon blacks, the use of further conductivity additives in the electrode composition is also conceivable. There may, for example, be a conductivity additive which is selected from the group consisting of carbon nanotubes, graphene, graphite, expanded graphite and carbon nanofibers (CNT), porous carbons, carbon nanofibers produced in the vapor phase (vapor-grown carbon fibers-VGCF), and combinations thereof.

In a further embodiment, the electrode comprises at least one electrode binder selected from the group consisting of polyvinylidene fluoride (PVDF), poly (vinylidene fluoride-hexafluoropropylene) copolymer (PVDF-HFP), polytetrafluoroethylene (PTFE), hydrogenated acrylonitrile-butadiene rubber (HNBR), carboxymethylcellulose (CMC), styrene-butadiene rubber (SBR), polyacrylate (PAA), lithium polyacrylate (LiPAA), and polyvinyl alcohol (PVA), and combinations thereof.

In one preferred embodiment, the electrode composition comprises the following components:
(A) 70% to 99%, preferably 90% to 98%, by weight of at least one active electrode material;
(B) 0.1% to 10%, preferably 1% to 4%, by weight of a mixture of conductive carbon blacks, the mixture comprising at least a first conductive carbon black and a second conductive carbon black, and the first conductive carbon black differing from the second conductive carbon black; and
(C) 0% to 10%, preferably 1% to 4%, by weight of at least one electrode binder selected from the group consisting of polyvinylidene fluoride (PVDF), poly (vinylidene fluoride-hexafluoropropylene) copolymer (PVDF-HFP), polytetrafluoroethylene (PTFE), hydrogenated acrylonitrile-butadiene rubber (HNBR), carboxymethylcellulose (CMC), styrene-butadiene rubber (SBR), polyacrylate (PAA), lithium polyacrylate (LiPAA), and polyvinyl alcohol (PVA), and combinations thereof;
wherein the fractions of the components (A) to (C) add up to 100 percent.

An electrode or lithium-ion battery produced with this electrode composition exhibits particularly good electrode and cell properties. In particular, the same electrode and cell properties as for conventionally produced lithium-ion batteries can be achieved, but with a reduced mixing time for the production of the electrode coating slurry.

The present disclosure further relates to an electrode with an electrode composition, the electrode composition comprising the components stated above.

According to a further aspect, the electrode comprises one of the electrode compositions stated above, more particularly an electrode composition having at least a first and a second conductive carbon black, the first conductive carbon black differing from the second conductive carbon black at least in terms of the mean particle diameter (d50) of the primary particles.

This affords the technical advantage that the macroscopic properties such as strength and/or adhesion of the electrode can be altered according to particle size distribution of the conductive carbon blacks used.

Where the fraction of conductive carbon blacks having a relatively large mean particle diameter is predominant, the calenderability of the electrode can be improved and the spring-back effect after calendering is reduced. Moreover, advantageously, the reaction of the composite electrode with the electrolyte, especially at high state of charge (SoC) and high temperature, can be attenuated.

Where the fraction of conductive carbon blacks having a relatively small mean particle diameter is predominant, the calenderability of the electrode may indeed be hindered and the spring-back effect after calendering reinforced. However, the electrical conductivity of the electrode can be improved in this way, and the lifetime and current robustness of the cell increased.

From the foregoing description it is clear that the properties of the electrode can be adapted in a targeted way according to the selection of the mean particle diameter of the conductive carbon blacks and hence of the particle size distribution.

A further subject of the present disclosure, accordingly, is the use of the electrode with the above-stated electrode composition in a lithium-ion battery.

### EXAMPLES

In the text below, various illustrative electrode compositions are given for electrodes. A distinction is made here between electrode compositions for anodes and cathodes.

The electrode compositions indicated are merely exemplary and should not be construed in a limiting sense.

### Example 1

### Reference Electrode Composition with Furnace Black

The reference composition with furnace black comprises 3% by weight of furnace black (from Imerys, BET surface area: 62 m²/g, mean particle diameter of the primary particles: 65 nm, oil absorption coefficient: 230 ml (100 g)⁻¹), polyvinylidene fluoride (from Solvay), and 95% by weight of active cathode material (from BASF, LMC 622).

### Example 2

### Reference Electrode Composition with Acetylene Black

The reference composition with pure acetylene black comprises 3% by weight of acetylene black (from Denka, BET surface area: 140 m²/g, mean particle diameter of the primary particles: 30 nm, oil absorption coefficient: 260 ml (100 g)−1), 2% by weight of polyvinylidene fluoride (from Solvay), and 95% by weight of active cathode material (from BASF, LMC 622).

### Example 3

### Mixture of Furnace Black and Acetylene Black According to the Present Disclosure

The electrode composition according to one exemplary embodiment of the present disclosure comprises 1.5% by weight of furnace black (from Imerys), 1.5% by weight of acetylene black (from Denka), 2% by weight of polyvinylidene fluoride (from Solvay) and 95% by weight of active cathode material (from BASF, LMC 622).

The production of electrodes from the electrode compositions of Examples 1 to 3, stated above, is explained below.

The production process indicated here for the electrodes should be understood as being purely illustrative. The electrodes may in principle be produced via various processes, which are known in the art.

First, polyvinylidene fluoride is dissolved in a carrier solvent. The carrier solvent may be N-methyl-2-pyrrolidone, for example. However, other organic solvents, such as acetone, and even water-based solvents, may also be used.

Next, with stirring, the conductive carbon black or, respectively, the conductive carbon blacks and the active electrode material are added.

The stirring is continued until a homogeneous suspension is present. A homogeneous electrode coating slurry is formed. The viscosity of the electrode coating slurry is adjusted preferably to 5 to 20 Pa s⁻¹, which is referred to as target viscosity. The viscosity may be adjusted by adding/evaporating the carrier solvent.

In the next step, the electrode coating slurry is applied with a doctor blade or a slot die to a current collector foil. In the case of a cathode, an aluminum foil may be used as current collector foil, and in the case of an anode, the current collector foil is preferably a copper foil.

The respective current collector foil with the applied electrode coating slurry is then dried.

All of the cathodes had a surface weight of 18 mg/cm² and an electrode density of 3.4 g/cm³.

The cathodes produced from Examples 1 to 3 may be put together with an anode to form a cell and measured for measurement of the electrode and cell properties of the electrodes resulting from the electrode compositions of Examples 1 to 3.

The anode composition of the anode may for example be 1% by weight of carboxymethylcellulose (CMC), 2% by weight of styrene-butadiene rubber (SBR), 1.5% by weight of conductive carbon black, and 95.5% by weight of active anode material such as synthetic graphite. The anode used was produced according to a process of the kind already described above for the cathodes. In particular, the anode composition was suspended in a carrier solvent and homogenized to give an electrode coating slurry. The carrier solvent used was water. The electrode coating slurry was subsequently coated onto copper foil and dried, to give a graphite anode.

The present disclosure, however, is not confined to the anode described. All of the anodes described in the art may be used.

The cathodes from Examples 1 to 3 were each put together with the graphite anode obtained above, to form a test cell. A single-layer pouch cell construction was used. In principle, however, other cell structures may also be used.

The cells 1 to 3 obtained were measured with an electrolyte consisting of a 1 M solution of lithium hexafluorophosphate in ethylene carbonate and diethyl carbonate (3:7; v:v).

The results of the test cells are reproduced in Table 1.

TABLE 1

| | | Number of cycles |
|---|---|---|
| | | to EoL (end of life, |
| Cell | Mixing time | 80% of initial capacity) |
| Test cell 1 | 1 hour | 500 |
| (cathode: Example 1/anode: | | |
| graphite anode) | | |
| Test cell 2 | 2 hours | 700 |
| (cathode: Example 2/anode: | | |
| graphite anode) | | |
| Test cell 3 | 1 hour 15 min | 700 |
| (cathode: Example 3/anode: | | |
| graphite anode) | | |

In Table 1, “Mixing time” means the time for which the electrode coating slurry is mixed, from the addition of the conductive carbon blacks and the active electrode material, until the suspension acquires a homogeneous appearance. “Number of cycles” denotes the number of charging and discharging cycles until 80% of the initial capacity is observed during cycling of the cell (=end of life).

Table 1 shows the different mixing times for producing the cathode electrode coating slurries, depending on the electrode compositions used from Examples 1 to 3. As is apparent from Table 1, the cathode electrode composition used in Example 1 has a shorter mixing time compared with the cathode electrode composition from Example 2 and with the electrode composition of the present disclosure from Example 3. The mixing time for producing the electrode coating slurries, however, is shorter in the case of the cathode electrode composition of the present disclosure (Example 3), in spite of the high fraction of acetylene black, than the mixing time for the cathode electrode coating slurry from Example 2.

From Table 1 it is additionally apparent that the cathode of the electrode composition of the present disclosure from Example 3 exhibits better electrode and cell properties than the cathode from Example 1. The cathode from Example 1 reaches only 500 cycles until the residual capacity (1C, 1C) is 80% relative to the initial capacity. Conversely, the cathode from Example 2 and the cathode of the electrode composition of the present disclosure each reach 700 cycles until the residual capacity (1C, 1C) has dropped to 80% of the initial capacity.

Surprisingly, the cathode of the electrode composition of the present disclosure, blended from equal parts of furnace black and acetylene black, exhibits the same number of cycles as the cathode from Example 2, in which acetylene black is the only conductive carbon black. Additionally, however, the mixing time needed for production of the cathode from Example 3, until the electrode coating slurry has a homogeneous appearance, is much lower. The use, in accordance with the present disclosure, of a mixture composed of a first and of a second conductive carbon black having different properties, in this case furnace black and acetylene black, hence produces a lithium-ion battery which displays advantageous cell properties and at the same time can be produced more simply, because the electrode coating slurry mixing times can be reduced. A lower mixing time also implies lower production costs, so that the production of the lithium-ion battery is more cost-effective as well.

Moreover, an electrode with the electrode composition of the present disclosure exhibits better adhesion on the aluminum foil and also a low spring-back behavior after calendering than the electrodes of the two reference examples.

1-12. (canceled)

13. An electrode composition for a lithium-ion battery, wherein the electrode composition comprises:
(A) at least one active electrode material; and
(B) at least one mixture of conductive carbon blacks that comprises at least a first conductive carbon black and a second conductive carbon black, the first conductive carbon black differing from the second conductive carbon black.

14. The electrode composition according to claim 13, wherein the first conductive carbon black and the second conductive carbon black differ in at least one property selected from the group consisting of: mean particle diameter; particle size distribution; secondary structure; specific BET surface area; electrical conductivity; oil absorption coefficient; bulk density; tap density; mode of production; impurities; and surface nature.

15. The electrode composition according to claim 13, wherein the first conductive carbon black and the second conductive carbon black each have a particle size distribution with a mean particle diameter in a range from 1 to 1000 nm, wherein the mean particle diameter of the first conductive carbon black differs from the mean particle diameter of the second conductive carbon black by at least 10%, and wherein the particle diameter is measured by electron microscopy.

16. The electrode composition according to claim 13, wherein the at least one mixture of conductive carbon blacks has a bimodal particle size distribution.

17. The electrode composition according to claim 13, wherein the first conductive carbon black and the second conductive carbon black each have a BET surface area in a range from 1 to 1000 m²·g−1, wherein the BET surface area of the first conductive carbon black differs from the BET surface area of the second conductive carbon black by at least 10%, and wherein the BET surface area is measured according to ASTM D6556-04.

18. The electrode composition according to claim 13, wherein the first conductive carbon black and the second conductive carbon black each have an oil absorption coefficient in a range from 1 to 800 mL (100 g)⁻¹, wherein the oil absorption coefficient of the first conductive carbon black differs from the oil absorption coefficient of the second conductive carbon black by at least 10%, and wherein the oil absorption coefficient is measured according to ASTM D2414-06 a.

19. The electrode composition according to claim 13, wherein one of the two conductive carbon blacks of component (B) is obtainable from an incomplete combustion process and the other conductive carbon black is obtainable from a thermal decomposition.

20. The electrode composition according to claim 13, wherein the first conductive carbon black is present in a fraction of 1% to 99% by weight in the mixture of component (B), based on the total weight of the mixture of component (B).

21. The electrode composition according to claim 13, wherein the electrode comprises at least one binder selected from the group consisting of polyvinylidene fluoride (PVDF), poly (vinylidene fluoride-hexafluoropropylene) copolymer (PVDF-HFP), polytetrafluoroethylene (PTFE), hydrogenated acrylonitrile-butadiene rubber (HNBR), carboxymethylcellulose (CMC), styrene-butadiene rubber (SBR), polyacrylate (PAA), lithium polyacrylate (LiPAA), polyvinyl alcohol (PVA), and combinations thereof.

22. The electrode composition according to claim 13, wherein the electrode composition comprises the following components:
(A) 70%-99% by weight of at least one active electrode material;
(B) 0.1%-10% by weight of a mixture of conductive carbon blacks, the mixture comprising at least a first conductive carbon black and a second conductive carbon black, and the first conductive carbon black differing from the second conductive carbon black; and, optionally,
(C) 0%-10% by weight of at least one binder selected from the group consisting of polyvinylidene fluoride (PVDF), poly (vinylidene fluoride-hexafluoropropylene) copolymer (PVDF-HFP), polytetrafluoroethylene (PTFE), hydrogenated acrylonitrile-butadiene rubber (HNBR), carboxymethylcellulose (CMC), styrene-butadiene rubber (SBR), polyacrylate (PAA), lithium polyacrylate (LiPAA), polyvinyl alcohol (PVA), and combinations thereof;
wherein the fractions of the components (A) to (C) add up to 100 percent.

23. An electrode comprising the electrode composition according to claim 13, wherein the electrode composition is applied to a current collector foil.

24. A lithium-ion battery comprising the electrode according to claim 23.

25. The lithium-ion battery according to claim 24, wherein the first conductive carbon black is furnace black and the second conductive carbon black is acetylene black.

26. The lithium-ion battery according to claim 24, wherein a residual capacity is 80% relative to an initial capacity after about 700 cycles.

27. A process for the production of an electrode for a lithium-ion battery, comprising:
adding a first conductive carbon black and a second conductive carbon black to a solution of a binder in a solvent to provide a mixture;
agitating the mixture to provide a homogeneous electrode coating slurry;
applying the slurry to a current collector foil to provide an applied slurry; and
drying the applied slurry;
wherein the first conductive carbon black differs from the second conductive carbon black.

28. The process according to claim 27, wherein the electrode has a surface weight of 18 mg/cm² and an electrode density of 3.4 g/cm³.

29. The process according to claim 27, wherein the agitating is for a duration of about 75 minutes.

30. The process according to claim 27, further comprising, after the agitating, adjusting a viscosity of the slurry to a target viscosity of from 5 Pa·s⁻¹ to 20 Pa·s⁻¹ by adding or evaporating the solvent.

31. The process according to claim 27, wherein the first conductive carbon black and the second conductive carbon black differ in at least one property selected from the group consisting of: mean particle diameter; particle size distribution; secondary structure; specific BET surface area; electrical conductivity; oil absorption coefficient; bulk density; tap density; mode of production; impurities; and surface nature.

32. The process according to claim 27, wherein the binder is selected from the group consisting of polyvinylidene fluoride (PVDF), poly (vinylidene fluoride-hexafluoropropylene) copolymer (PVDF-HFP), polytetrafluoroethylene (PTFE), hydrogenated acrylonitrile-butadiene rubber (HNBR), carboxymethylcellulose (CMC), styrene-butadiene rubber (SBR), polyacrylate (PAA), lithium polyacrylate (LiPAA), polyvinyl alcohol (PVA), and combinations thereof.
